(19) United States
(12) Patent Application Publication
(10) Pub. No.: US 2025/0276350 A1
(43) Pub. Date: Sep. 4, 2025

(54) Biotic Material Sink

(71) Applicant: Elden James Curtis, Squamish (CA)

(72) Inventor: Elden James Curtis, Squamish (CA)

(21) Appl. No.: 19/055,541

(22) Filed: Feb. 18, 2025

(30) Foreign Application Priority Data
Mar. 1, 2024 (CA) 3231603

(51) Int. Cl. B09B 1/00

(52) U.S. Cl. CPC B09B 1/00

(57) ABSTRACT

Disclosed are processes and methods for slowing decomposition and degradation of biotic material. In particular, the process includes an amount of biotic material that is deposited in a natural depression or manmade excavation before, during or after deposition and intermixing of a water and regolith mixture, added together or separately, with the biotic material, whereby atmospheric gas is driven out of the biotic material, connate water content in the biotic material and water and regolith mixture deposit is increased, and the biotic material is buried in the regolith and water mixture. Advantageously, the rate of decomposition and degradation of said biotic material is immediately reduced, thereby slowing the release of greenhouse gases, such as carbon dioxide and methane, to the atmosphere.

### BACKGROUND OF THE INVENTION

### Field of the Invention

Embodiments of the present disclosure generally relate to carbon sequestration and reduction of greenhouse gas emissions to the atmosphere. In particular, the present disclosure describes processes and methods for slowing decomposition and degradation of biotic material. The biotic material sink process includes a unique set of steps which perform to allow biotic material to be buried in a low atmospheric gas, low energy environment to thereby reduce decomposition and degradation of the biotic material. Thus, biotic material can be used as a source of potential greenhouse gas emissions to sequester from the environment for a reduction in the rate of greenhouse gas emissions to the atmosphere. Scientific understanding of biological process and of atmospheric interactions with solar radiation provide insight for this invention. A background in mining may help to provide insight to the management of regolith moving and ground fluid management.

### Description of Prior Art

Greenhouse gases such as carbon dioxide and methane are believed to increase radiation retention in the earth's atmosphere. This is believed, by way of scientific modelling, to increase the energy intensity of weather occurrences such as storms, hurricanes, tornadoes and the like. Such events cause flooding, loss of life and property and increased insurance costs as a result. This has pushed society to find ways of reducing greenhouse gas emissions to the atmosphere. In some societies industrial emissions are now being taxed for their destructive potential by some governments.

This has led to numerous inventions of the purpose of reducing the release of greenhouse gas emissions to the atmosphere. In general, these inventions, such as Patent CA 3076090, Gas Capture System, by COMPACT CARBON CAPTURE AS, provide for a treatment of gas sourced from an industrial flow of emissions. Some inventions will expose these emissions to different uptake materials, such as Patent CA 2771486, Carbon Dioxide Absorbent, by ADVANCED CARBON CAPTURE AS. This gas manipulation and control mode of invention leads to many intricate and complicated chemical and industrial methods. The costs for such methods are prohibitive in many situations. Alternate methods of greenhouse gas emissions reductions are needed.

### SUMMARY OF THE INVENTION

In accordance with an aspect of the disclosure, a process is provided comprising: a natural depression or manmade excavation selected to contain a deposit; an amount of biotic material deposited in said depression or excavation; a mixture of water and regolith deposited in said depression or excavation; a method of intermixing said biotic material with said water and regolith mixture wherein the kinetic work of depositing of said biotic material with said mixture intermixes said biotic material and said mixture, or said biotic material is intermixed with said mixture by additional kinetic work; and the deposited biotic material is buried by the water and regolith mixture. In some embodiments, the biotic material is deposited before, during or after depositing of the water and regolith mixture. In some embodiments, the water and regolith components of the water and regolith mixture are added separately. In some embodiments, the biotic material is intermixed with the water and regolith mixture prior to deposition.

In some embodiments, the flexibility possessed by the invention resides in its ability to use a manmade excavation such as an expired mine site to contain the biotic material sink and reduce water loss to the ground surrounding the biotic material sink area, or to use a natural depression such as a bog or valley bottom to maintain moisture content or reduce water loss to ground water flow. This allows a site to be selected near to sources of biotic material reducing transport costs.

In addition to the foregoing attributes, the invention possesses numerous other cost reduction benefits for mine and industrial sites. Greenhouse gas emissions release to the atmosphere pricing by governments, used to discourage greenhouse gas emissions, will allow these mines and industrial sites to recoup excavation costs by claiming carbon credits for biotic material sink stored biotic material. Moreover, waste biotic material from land clearing and logging will also gain monetary value as a source for carbon capture and storage, where before the material would be left to rot or burn, which can eventually release the waste biotic material into the atmosphere as greenhouse gas emissions such as carbon dioxide and methane.

### BRIEF DESCRIPTION OF THE DRAWINGS

The drawings described herein are for illustration purposes only and are not intended to limit the scope of the present disclosure in any way.

FIG. 1 is an exemplary illustration of a manmade excavation 101, positioned on the floor of a valley, to be used as a biotic material sink, with a layer of biotic material 102, which, by way of example and not limitation, is represented by trunks of trees killed in a forest fire which are not totally destroyed nor possessing commercial value, positioned on the floor of said excavation, in accordance with an embodiment of the present disclosure.

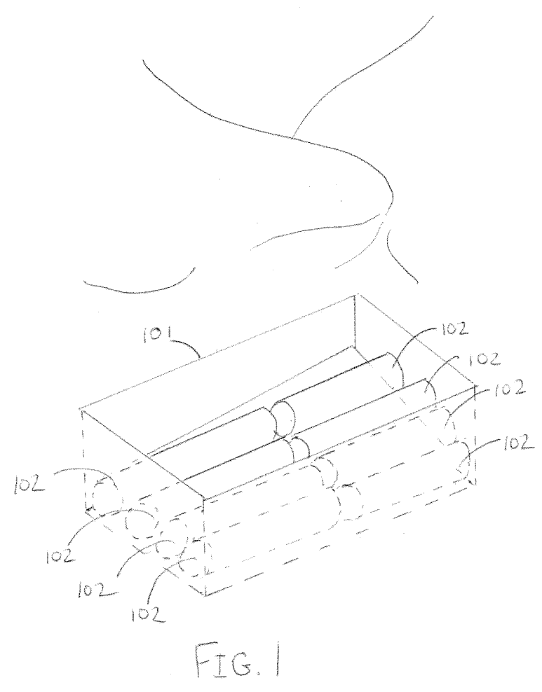

FIG. 2 is an exemplary illustration of the manmade excavation and biotic material from FIG. 1 with a machine, 201, adding regolith, 202, to biotic material, 203, while a water monitor, 204, adds the water component, 205, of the water and regolith mixture to help fill air pockets close to the surface of the biotic material as well as to moisturize the regolith particles in close proximity or contact with the biotic material itself to induce deposition and stratification of regolith and water around the biotic material and thus increase the prevalence of connate water in the biotic material sink, in accordance with an embodiment of the present disclosure.

FIG. 3 is an exemplary illustration of a full scale biotic material sink used to maximize carbon storage and containment in a former mine site. Layers of biotic material sink 301, 302 and 303 are stacked on top of each other, in accordance with an embodiment of the present disclosure.

### DESCRIPTION OF THE PREFERRED EMBODIMENT

Disclosed herein are processes and methods for slowing the decomposition and degradation of biotic material. In some embodiments, the processes and methods slow decomposition and degradation of biotic material by decreasing atmospheric gas sources available to bacteria, fungus or fire. In some embodiments, the processes and methods slow decomposition and degradation of biotic material by increasing connate water in biotic material sink. The biotic material sink processes and methods described herein are efficient and greatly slow the decomposition and degradation of biotic material.

Definitions. For convenience, certain terms employed in the specification, examples, and appended claims are collected here.

The articles “a” and “an” are used herein to refer to one or to more than one (i.e., to at least one) of the grammatical object of the article. By way of example, “an element” means one element or more than one element.

As used herein in the specification and in the claims, “or” shall be interpreted as being inclusive, i.e., the inclusion of at least one, but also including more than one, of a list of elements, and optionally, additional unlisted items. In general, the term “or” as used herein shall only be interpreted as indicating exclusive alternatives (i.e., “one or the other but not both”) when preceded by terms of exclusivity, such as “either,” “only one of,” or “exactly one of.” Only terms clearly indicated to the contrary such as “consisting of” will refer to the inclusion of exactly one element of a number or list of elements. It should also be understood that, unless clearly indicated to the contrary, in any methods claimed herein in the claims or specification, that include more than one step or act, the order of the steps or acts of the method is not necessarily limited to the order in which the steps or acts of the method are recited.

In the claims, as well as in the specification, all transitional phrases such as “comprising,” “including,” “depositing,” “having,” “containing,” “involving,” “holding,” “composed of” and the like are to be understood as open-ended, i.e., to mean including but not limited to. Only the transitional phrases “consisting of” and “consisting essentially of” shall be closed or semi-closed transitional phrases, respectively.

The term “water monitor” as used herein refers to a device that controls the direction or characteristics (e.g., velocity) of water flow as it exits an enclosed chamber, pipe or hose.

The term “biotic material” as used herein refers to any material that originates from living organisms

The term “regolith” as used herein refers to loose unconsolidated rock, dust or soil that sits atop a layer of bedrock.

The term “decomposition” as used herein refers to biotic material being broken down by bacterial or fungal action.

The term “degradation” as used herein refers to biotic material being broken down by natural environmental conditions such as U.V. light and forest fire.

The term “connate water” as used herein refers to water that is trapped in the pores of the regolith as it is deposited, as well as water trapped by layers of regolith in close proximity to or touching deposited biotic material.

In various embodiments, the processes and methods described herein are capable of slowing decomposition and degradation of biotic material. In various embodiments, the processes and methods described herein provide several advantages over processes and methods in the prior art. In particular, the invention utilizes carbon in biotic form rather than current carbon capture and storage which involves capturing carbon dioxide and other gases from industrial emissions. Moreover, the current industrial emissions capture technology requires costly infrastructure for capturing, transporting and underground injecting the industrial emissions gases. Moreover, the availability of natural depressions and manmade excavations allow for more flexibility when selecting a storage site for a biotic material sink compared to finding gas injectable geological formations. Moreover, the biotic materials, regolith and water are readily and widely available compared to industrial gas emission sources. Moreover the current carbon capture and storage may be cost prohibitive and thus negate the potential of these gas capture systems. In various embodiments, the deposition of the water portion of the water and regolith mixture may be added separately from the regolith. In various embodiments, the water portion of the water and regolith mixture may be deposited with a device, such as a water monitor, to thereby provide a higher water pressure to thereby further agitate the deposited regolith and biotic material. In various embodiments, the water portion of the water and regolith mixture may be deposited with a device, such as a water monitor, to provide a greater area of water distribution with lower water flow to thereby use less water in the water and regolith mixture deposited with the biotic material. In various embodiments, the biotic material may be mechanically reduced in particle size or selected in particle size such that it can be pumped in a slurry. In various embodiments, the regolith portion of the water and regolith mixture may be mechanically reduced in particle size or selected in particle size such that it can be pumped in a slurry. In various embodiments, the biotic material and water and regolith mixture will be pumped together in a slurry into the natural depression or manmade excavation. In various embodiments, the natural depression or manmade excavation selected to contain biotic material sink may be altered to facilitate deposition of the biotic material and water and regolith mixture. In various embodiments, the natural depression or manmade excavation may be altered to maintain water content in the biotic material sink. In various embodiments, the natural depression or manmade excavation may be mechanically altered to contain the biotic material sink. In various embodiments, the water and regolith mixture, consisting of a minimum of 1% water and a maximum of 99% water and the remainder of the mixture consisting of regolith, can be added to the biotic material as individual mixture components or at the same time. In some embodiments, the intermixing of the biotic material and water and regolith mixture is accomplished as a result of the kinetic work of depositing the biotic material and water and regolith mixture. In some embodiments, the intermixing of the biotic material and water and regolith mixture is a result of additional kinetic work, such as mechanical manipulation of the components of the biotic material sink. In various embodiments, intermixing of the water and regolith mixture with biotic material is accomplished by spraying of the water component of the water and regolith mixture when depositing the regolith with the biotic material. In various embodiments, the intermixing method has the effect of driving an amount of atmospheric gas out of the biotic material layer, immediately reducing decomposition and degradation by lowering oxygen availability and reducing external energy availability. In various embodiments, the intermixing of the water and regolith mixture in the presence of the biotic material will allow the regolith to absorb and retain moisture close to the biotic material surface, replacing gases being retained in the pores and air pockets of the biotic material as well as the pores of the individual particles of the regolith itself. In various embodiments, intermixing said biotic material and said water and regolith mixture produces connate water layers on, around and through the biotic material sink deposit, thereby limiting gas transfer through the biotic material sink and further slowing decomposition and degradation of the biotic material by blocking an amount of additional atmospheric gas exposure. In various embodiments, the first deposit of biotic material sink will be covered by further deposits of biotic material sink, which will provide increased weight and thus pressure on the lower layers of biotic material sink and to thereby slow the movement of gas and moisture to and from said lower biotic material sink deposits. In various embodiments, the biotic material will be buried completely in the water and regolith mixture.

Further areas of applicability will become apparent from the description provided herein. It should be understood that the description and specific examples are intended for purposes of illustration only and are not intended to limit the scope of the present disclosure.

The following description is merely exemplary in nature and is not intended to limit the present disclosure, application, or uses. It should be understood that throughout the drawings, corresponding reference numerals indicate like or corresponding parts and features.

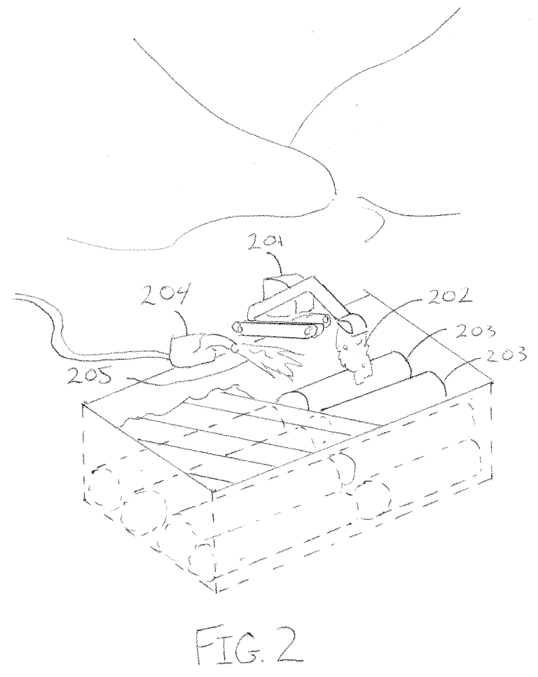

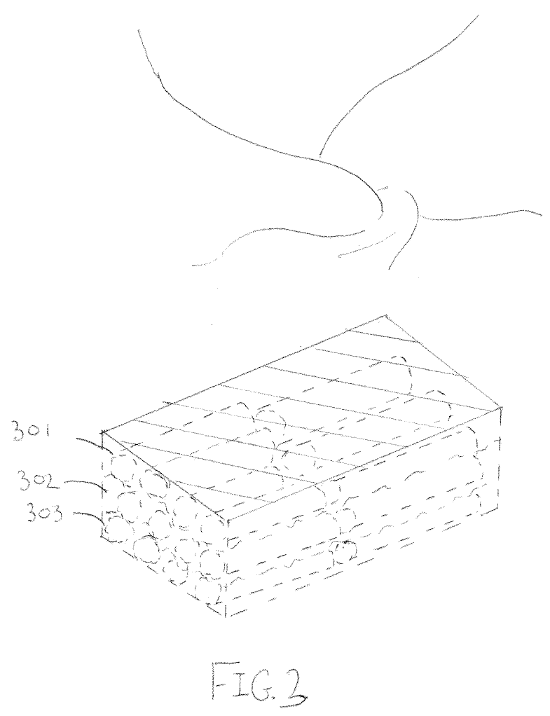

In various aspects, the present disclosure provides a process for reducing the decomposition and degradation of biotic material by burying said biotic material in a low air and connate water rich environment. In various embodiments, the biotic material deposited in a selected natural depression or manmade excavation will be intermixed with the water and regolith mixture by the kinetic work of depositing said material and said mixture. In some embodiments, such as shown if FIG. 2, the water portion of the water and regolith mixture can be added by water monitor, which will have the desired effect of collapsing air pockets around the biotic material. In some embodiments, such as shown in exemplary illustration FIG. 2, the water portion of the water and regolith mixture can be added by a water monitor, which will have the desired effect of causing dripping water in interaction with the biotic material and regolith, forming connate water layers in the biotic material sink. In various embodiments, such as the exemplary illustration FIG. 2, the biotic material is old, such as trees not completely destroyed by a forest fire. In various embodiments, the exemplary biotic material is fresh, but has no commercial value. In various embodiments, such as shown in exemplary illustration FIG. 3, a full scale biotic material sink system can fill, by way of example and not limitation, a large mine site excavation at the end of a mining project. In various embodiments, layers of biotic material sink are stacked on top of each other to increase the amount of biotic material contained in a site or to increase the pressure on lower layers of biotic material sink, for the purpose of reducing atmospheric gas passing through the biotic material sink. In various embodiments, the biotic material sink process allows the mine site to enter a second phase of operation for sequestering biotic material and thus reducing greenhouse gas emissions to the atmosphere from decomposition and degradation of biotic material. In various embodiments, the same mining roads and machinery used to mine can be used to transport and deposit the biotic material sink. As some governments already tax carbon dioxide release, some costs of mining could be recouped through biotic material sink implementation for carbon tax credits.

The embodiments of the invention in which exclusive property or privilege is claimed are defined as follows:

1. A process for slowing decomposition and degradation of biotic material comprising:
a natural depression or manmade excavation;
an amount of biotic material deposited in said natural depression or manmade excavation;
an amount of water and regolith mixture deposited in said natural depression or manmade excavation;

2. The process of claim 1, wherein said amount of biotic material can be deposited before, during or after said water and regolith mixture is deposited.

3. The process of claim 1, wherein said water and regolith mixture consists of between 1% and 99% water and the remainder of said mixture consists of regolith.

4. The process of claim 1, wherein said water and regolith components of said water and regolith mixture can be added to said amount of biotic material together or separately.

5. A method for slowing decomposition and degradation of biotic material, according to one of claims 1 to 4, comprising:
selecting a natural depression or manmade excavation;
depositing an amount of biotic material in said natural depression or manmade excavation before, during or after depositing an amount of water and regolith mixture, said mixture consisting of between 1% water and 99% water and the remainder consisting of regolith, in said depression or excavation;
intermixing said amount of biotic material and said amount of water and regolith mixture by result of kinetic work depositing said amount of biotic material and said water and regolith mixture in said natural depression or manmade excavation, or by intermixing said biotic material and said water and regolith mixture, during depositing, by additional kinetic work, to thereby expel an amount of air out of the biotic material as well as from the pores of the regolith portion of said water and regolith mixture and to thereby create an amount of connate water content in said biotic material and water and regolith mixture;
and burying said amount of biotic material in said water and regolith mixture to thereby sequester said biotic material from atmospheric gas and produce a biotic material sink.

6. The method of claim 5, wherein the first biotic material sink deposit is covered by additional biotic material sink layers to thereby increase the size and manageability of the overall biotic material sink and to thereby further decrease gas transfer into or out of the biotic sink deposit.
